(19) United States
(12) Patent Application Publication
(10) Pub. No.: US 2010/0322587 A1
(43) Pub. Date: Dec. 23, 2010

(54) POLYIMIDE COMPOUND, PREPARATION METHOD THEREFOR, AND OPTICAL FILM AND OPTICAL WAVEGUIDE PRODUCED BY EMPLOYING THE COMPOUND

(75) Inventor: Tomoyuki Hirayama, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 12/813,665

(22) Filed: Jun. 11, 2010

(30) Foreign Application Priority Data
Jun. 23, 2009 (JP) 2009-148470

(51) Int. Cl. G02B 6/00; C08G 69/26

(52) U.S. Cl. 385/142; 528/353; 385/144

(57) ABSTRACT

A novel polyimide compound which has a lower linear expansion coefficient and permits film formation by a spin coating method or the like, a preparation method for the polyimide compound, and an optical film and an optical waveguide produced by employing the compound. The polyimide compound has a structural unit represented by the following general formula (1):

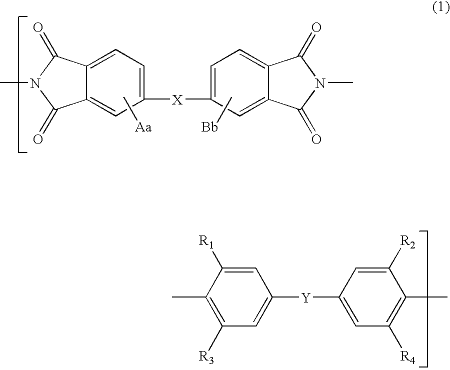

wherein X and Y are each a covalent single bond, —CO—, —O—, —CH₂—, —C(CF₃)₂— or —CR(R′)— (wherein R and R′, which may be the same or different, are each a linear or branched C₁ to C₄ alkyl group); A and B are each a halogen group; a and b, which are the numbers of the groups A and B, respectively, are each 0 or an integer of 1 or 2; and R₁, R₂, R₃ and R₄, which may be the same or different, are each a hydrogen atom or a linear C₁ to C₄ alkyl group.

### BACKGROUND OF THE INVENTION

1. Field of the Invention

The present invention relates to a polyimide compound, a preparation method therefor, and an optical film and an optical waveguide produced by employing the compound.

2. Description of the Related Art

Conventionally, plastic materials containing essentially a polyimide resin, an epoxy resin or an acrylate resin are often used in the field of optics. Such optical resins are generally required to have heat resistance, moisture resistance and other various properties depending upon their applications. To this end, various types of optical resins have been developed, which are imparted with various properties by modifying a main chain and a side chain of a polymeric skeletal structure. Particularly, highly transparent plastic materials for use as sealing materials for optical elements and for use as materials for flexible wiring boards are now under consideration for application to optical waveguides (see JP-A-2003-89779, JP-A-HEI8 (1996)-41323 and JP-A-2002-201231).

With the recent trend toward higher information capacity and higher information transmission speed, focus is directed to development of opto-electric hybrid boards. Such a board typically includes a metal substrate (including a substrate having a metal layer) and an optical waveguide provided on the substrate. Depending upon the type of the substrate to be used, the linear expansion coefficient of a resin material for the optical waveguide should be properly controlled. This is because the metal substrate has a lower linear expansion coefficient while a conventional ordinary resin material for the optical waveguide has a higher linear expansion coefficient. Where a layer of the resin material is formed on the metal substrate, the resulting board is liable to be thermally warped (or curled) (due to heat applied during production thereof or ambient heat applied after the production thereof).

A conceivable approach to this problem is to introduce a crosslink structure into the resin material to reduce the linear expansion coefficient. The easiest method for providing the crosslink structure is, for example, to introduce a multifunctional group. However, this method suffers from gelation of a polymer, making it difficult to form a coating film by applying a resin composition (e.g., by a spin coating method or the like) for the formation of the optical waveguide or the like.

In view of the foregoing, it is an object of the present invention to provide a novel polyimide compound which has a lower linear expansion coefficient and permits film formation by the spin coating method or the like, a preparation method for the compound, and an optical film and an optical waveguide produced by employing the compound.

### SUMMARY OF THE INVENTION

According to a first aspect of the present invention to achieve the aforementioned object, there is provided a polyimide compound having a structural unit represented by the following general formula (1):

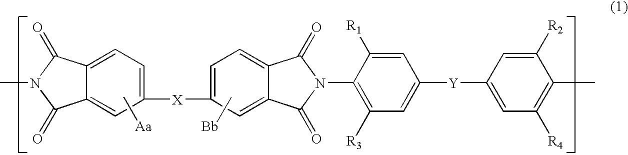

wherein X and Y are each a covalent single bond, —CO—, —O—, —CH₂—, —C(CF₃)₂— or —CR(R′)— (wherein R and R′, which may be the same or different, are each a linear or branched C₁ to C₄ alkyl group); A and B are each a halogen group; a and b, which are the numbers of the groups A and B, respectively, are each 0 or an integer of 1 or 2; and R₁, R₂, R₃ and R₄, which may be the same or different, are each a hydrogen atom or a linear C₁ to C₄ alkyl group.

According to a second aspect of the present invention, there is provided a preparation method for the aforementioned polyimide compound, the method comprising the steps of: causing a tetracarboxylic dianhydride represented by the following general formula (2) and a diamino compound represented by the following general formula (3) to react with each other to prepare a polyamic acid in a liquid form; and imidizing the polyamic acid in the liquid form.

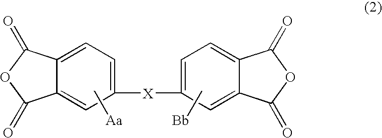

wherein X is a covalent single bond, —CO—, —O—, —CH₂—, —C(CF₃)₂— or —CR(R′)— (wherein R and R′, which may be the same or different, are each a linear or branched C₁ to C₄ alkyl group); A and B are each a halogen group; and a and b, which are the numbers of the groups A and B, respectively, are each 0 or an integer of 1 or 2.

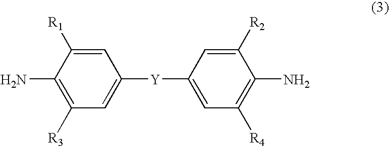

wherein Y is a covalent single bond, —CO—, —O—, —CH₂—, —C(CF₃)₂— or —CR(R′)— (wherein R and R′, which may be the same or different, are each a linear or branched C₁ to C₄ alkyl group); and R₁, R₂, R₃ and R₄, which may be the same or different, are each a hydrogen atom or a linear C₁ to C₄ alkyl group.

According to a third aspect of the present invention, there is provided an optical film composed of a resin comprising the aforementioned polyimide compound as a matrix polymer.

According to a fourth aspect of the present invention, there is provided an optical waveguide comprising a substrate, a cladding layer provided on the substrate, and a core provided in a predetermined pattern in the cladding layer for transmission of an optical signal, at least one of the cladding layer and the core being composed of a resin comprising the aforementioned polyimide compound as a matrix polymer.

The inventor of the present invention conducted a series of studies to solve the aforementioned problems, and conducted experiments by synthesizing various compounds each having a specific structure. As a result, the inventor found that the object described above is achieved by using the novel polyimide compound having the structural unit represented by the above general formula (1), and attained the present invention. The inventor found that the novel polyimide compound has the aforementioned specific skeletal structure, which reduces the linear expansion coefficient of the polyimide compound. Further, the inventor found that the novel polyimide compound can be prepared by imidizing the polyamic acid (polyimide precursor) synthesized by causing the tetracarboxylic dianhydride represented by the above general formula (2) and the diamino compound represented by the above general formula (3) to react with each other.

Intrinsically, polyimide resins each have a linear expansion coefficient closer to that of a metal due to strong π-π interaction. In order to provide a transparent aromatic polyimide for applications to optical waveguides and other optics, however, the molecule design of the polyimide is directed to suppression of charge transfer (CT) in its main chain by introducing an electron attractive site such as of a fluorine atom or a trifluoromethyl group to the main chain. This significantly reduces interaction between polymer main chains due to an F—F inter-atomic repulsive force, thereby increasing the thermal (linear) expansion coefficient of the polymer (for example, a partly fluorinated polyimide (6FDA-TFMB) prepared by synthesizing 4,4′-(hexafluoroisopropylidene) diphthalic dianhydride and 2,2′-bis(trifluoromethyl)-4,4′-diaminobiphenyl (TFMB) has a linear expansion coefficient of about 40 ppm/° C.). In the molecule design of the prior art transparent polyimide, the transparency and the linear expansion coefficient are antithetical to each other (in trade-off relation). However, the molecule design of the inventive polyimide compound is directed to reduction of the amount of fluorine atoms present in the molecule by introducing a twisted structure in the polymer main chain, thereby reducing the linear expansion coefficient without impairing the transparency. Although a prior art fluorinated polyimide inevitably suffers from a light loss in a wavelength range of 1000 nm or less due to the π-π interaction between main chains, the present invention effectively reduces the light loss.

As described above, the inventive polyimide compound is a specific polyimide compound having the structural unit represented by the above general formula (1). This compound has a lower linear expansion coefficient because of its specific skeletal structure. Therefore, where a layer of a resin comprising the polyimide compound as a matrix polymer is formed on a metal substrate having a lower linear expansion coefficient, for example, the resulting board is substantially free from thermal warpage which may otherwise occur due to heat (heat applied during production thereof or ambient heat applied after the production). Therefore, the inventive polyimide compound is useful as a material for an optical waveguide including a metal substrate. The inventive polyimide compound is highly transparent and, therefore, useful as an optical material for an optical film, a liquid crystal display substrate, a micro lens and the like. Further, the inventive polyimide compound is excellent in heat resistance and alkali developability and, therefore, useful as a solder resist material for a flexible circuit board to be mounted with an electronic component such as a semiconductor element by soldering. The polyamic acid, which is a precursor of the inventive polyimide compound, is provided in the liquid form and, therefore, permits film formation by a spin coating method or the like.

The inventive polyimide compound having the aforementioned specific skeletal structure as the structural unit can be synthesized by causing the specific tetracarboxylic dianhydride and the specific diamino compound to react with each other to prepare the polyamic acid (polyimide precursor) in the liquid form, and imidizing the polyamic acid.

The optical film composed of the resin comprising the polyimide compound as the matrix polymer, even if having a smaller thickness, is less liable to suffer from thermal warpage and distortion which may otherwise occur due to heat (heat applied during production thereof or ambient heat applied after the production), because the polyimide compound has a lower linear expansion coefficient.

Like the aforementioned optical film, the optical waveguide produced by employing the resin comprising the polyimide compound as the matrix polymer is less liable to suffer from thermal warpage and distortion. Particularly, the thermal warpage and distortion of the optical waveguide including the metal substrate having a lower linear expansion coefficient can be significantly suppressed as compared with the conventional optical waveguide produced by employing the ordinary optical waveguide resin material.

### BRIEF DESCRIPTION OF THE DRAWING

FIG. 1 is a diagram for explaining a curl test conducted in Examples.

### DETAILED DESCRIPTION

The present invention will hereinafter be described by way of embodiments thereof.

A polyimide compound according to the present invention is a compound having a structural unit represented by the following general formula (1). In the following general formula (1), X and Y are each a single bond (covalent single bond), —CO—, —O—, —CH₂—, —C(CF₃)₂— or —CR(R′)—. Particularly, X is preferably —C(CF₃)₂— for transparency. In —CR(R′)—, R and R′, which may be the same or different, are each a linear or branched C₁ to C₄ alkyl group. In the following general formula (1), A and B are each a halogen group, and a and b, which are the numbers of the groups A and B, respectively, are each 0 or an integer of 1 or 2. Thus, the structural unit may optionally contain the halogen groups A and B. Further, R₁, R₂, R₃ and R₄, which may be the same or different, are each a hydrogen atom or a linear C₁ to C₄ alkyl group. Both block polymerization and random polymerization are acceptable for the following general formula (1).

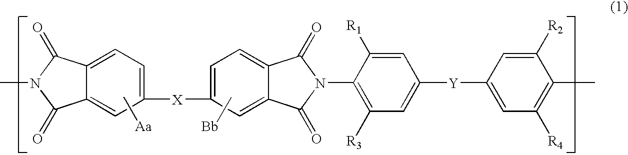

The inventive polyimide compound, which has the specific skeletal structure represented by the above general formula (1), has a lower linear expansion coefficient. More specifically, the inventive polyimide compound has a linear expansion coefficient of not higher than 35 ppm/° C., preferably 10 to 20 ppm/° C. The linear expansion coefficient is measured, for example, by means of a thermomechanical analyzer (TMA).

The inventive polyimide compound preferably has a weight average molecular weight (Mw) of 10000 to 200000, more preferably 50000 to 100000. If the weight average molecular weight is less than 10000, the polyimide compound tends to be poorer in physical properties such as heat resistance (e.g., heat resistance during a solder reflow process) and film formability. If the weight average molecular weight is greater than 200000, the polyimide compound tends to have an excessively high viscosity and, therefore, is difficult to handle. The weight average molecular weight is measured, for example, by gel permeation chromatography (GPC) based on polystyrene calibration standards.

The inventive polyimide compound having the structural unit represented by the above general formula (1) can be prepared by causing a tetra carboxylic dianhydride represented by the following general formula (2) and a diamino compound represented by the following general formula (3) to react with each other to prepare a polyamic acid (polyimide precursor) in a liquid form, and then imidizing the polyamic acid in the liquid form.

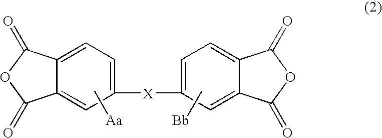

wherein X is a covalent single bond, —CO—, —O—, —CH₂—, —C(CF₃)₂— or —CR(R′)— (wherein R and R′, which may be the same or different, are each a linear or branched C₁ to C₄ alkyl group); A and B are each a halogen group; and a and b, which are the numbers of the groups A and B, respectively, are each 0 or an integer of 1 or 2.

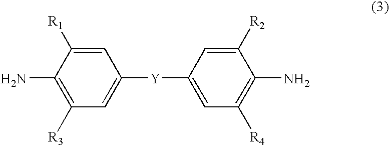

wherein Y is a covalent single bond, —CO—, —O—, —CH₂—, —C(CF₃)₂— or —CR(R′)— (wherein R and R′, which may be the same or different, are each a linear or branched C₁ to C₄ alkyl group); and R₁, R₂, R₃ and R₄, which may be the same or different, are each a hydrogen atom or a linear C₁ to C₄ alkyl group.

Examples of the tetracarboxylic dianhydride represented by the above general formula (2) include 4,4′-(hexafluoroisopropylidene)diphthalic dianhydride (6FDA), 3,3′,4,4′-benzophenonetetracarboxylic dianhydride and 4,4′-oxydiphthalic dianhydride, which may be used either alone or in combination.

Examples of the diamino compound represented by the above general formula (3) include 3,3′-dimethylbenzidine (DMBA), 3,3′,5,5′-tetramethylbenzidine (TMBA), 9,9-bis(4-amino-3-methylphenyl)fluorene and 9,9-bis(4-amino-3-fluorophenyl)fluorene, which may be used either alone or in combination.

The tetracarboxylic dianhydride represented by the above general formula (2) and the diamino compound represented by the above general formula (3) are employed as synthesis ingredients, and caused to react with each other for preparation of the polyamic acid (polyimide precursor). 2,2′-bis(trifluoromethyl)-4,4′-diaminobiphenyl (TFMB), which is different from a diamino compound represented by the said general formula (3) may also be used as said synthesis ingredients accordingly. The reaction temperature for preparation of said polyamic acid (polyamide precursor) is preferably 20° C. to 80° C., particularly preferably 20° C. to 40° C.

In the present invention, a reaction solvent is generally used for the synthesis of the polyamic acid. Preferred examples of the reaction solvent include aromatic hydrocarbons (such as toluene and xylene), ethers (such as tetrahydrofuran and dibutyl ether) and aprotic polar solvents (such as N-methylpyrrolidone, N-methyl-2-pyrrolidone, N,N-dimethylformamide and N,N-dimethylacetamide), which may be used either alone or in combination.

The imidization of the polyamic acid thus prepared is achieved by thermal imidization or the like. More specifically, the imidization temperature is preferably 150° C. to 400° C., particularly preferably 200° C. to 400° C.

The inventive polyimide compound thus prepared is highly transparent and, therefore, useful as an optical material for an optical waveguide, an optical film, a liquid crystal display substrate or a micro lens, or a sealing material for an optical element. Further, the inventive polyimide compound is excellent in heat resistance and alkali developability and, therefore, useful as a solder resist material for a flexible circuit board to be mounted with an electronic component such as a semiconductor element by soldering. Since the polyamic acid serving as the precursor of the inventive polyimide compound is provided in the liquid form, it is possible to form a film of the inventive polyimide compound by a coating method. Examples of the coating method include those employing a spin coater, a coater, a disk coater and a bar coater, a roll-to-roll continuous coating method employing a coating machine such as a multi-coater, a screen printing method and an electrostatic coating method.

An optical film composed of a resin containing the polyimide compound as a matrix polymer, even if having a smaller thickness, is less liable to suffer from thermal warpage and distortion which may otherwise occur due to heat (heat applied during production thereof or ambient heat applied after the production), because the polyimide compound has a lower linear expansion coefficient.

Like the optical film, an optical waveguide produced by employing a resin containing the polyimide compound as a matrix polymer is less liable to suffer from thermal warpage and distortion. Particularly, the thermal warpage and distortion of an optical waveguide including a metal substrate having a lower linear expansion coefficient can be significantly suppressed as compared with the conventional optical waveguide produced by employing the ordinary optical waveguide resin material.

The expression “a resin containing the polyimide compound as a matrix polymer” herein means not only a resin containing the polyimide compound alone but also a resin optionally containing a tackifier, a flexibilizer, an antioxidant, a defoaming agent and the like in addition to the polyimide compound as the resin material. These additives are each blended in a proportion such as not to impair the effects of the present invention.

The inventive optical waveguide includes a substrate, a cladding layer provided on the substrate, and a core provided in a predetermined pattern in the cladding layer for transmission of an optical signal. In the inventive optical waveguide, at least one of the cladding layer and the core is composed of a resin containing the polyimide compound as a matrix polymer.

A material for the substrate is not limited to a metal, but a polymer film or a glass substrate may be used. Specific examples of the polymer film include polyethylene terephthalate (PET) films, polyethylene naphthalate films and polyimide films. The substrate typically has a thickness of 10 μm to 3 mm.

Examples of the optical waveguide include a linear optical waveguide, a curved optical waveguide, a cross optical waveguide, a Y-branched optical waveguide, a slab optical waveguide, a Mach-Zehnder optical waveguide, an AWG type optical waveguide, a grating and an optical waveguide lens. Examples of optical devices employing such optical waveguides include a wavelength filter, an optical switch, an optical divider, an optical multiplexer, an optical multiplexer/demultiplexer, an optical amplifier, a wavelength converter, a wavelength divider, an optical splitter, a directional coupler and a light transmission module provided by hybrid integration of a laser diode and a photodiode.

Next, inventive examples will be described in conjunction with a comparative example. It should be understood that the present invention be not limited to the inventive examples.

### Example 1

### Synthesis of Polyamic Acid Solution

First, 2.39 g of 3,3′-dimethylbenzidine (DMBA) was dissolved in 18.3 ml of dry N,N-dimethylacetamide in a reaction vessel provided with a stirrer. Then, 5.00 g of 4,4′-(hexafluoroisopropylidene)diphthalic dianhydride (6FDA) was slowly added to the resulting solution with stirring, and the resulting mixture was further stirred at 40° C. for 5 hours. Thus, an N,N-dimethylacetamide solution of a polyamic acid (polyimide precursor) was prepared (which had a solid concentration of 30% and an overall weight of 24.1 g).

### Production of Polyimide Film

The solution of the polyamic acid thus prepared was applied onto a glass substrate by a spin coating method. The resulting coating film was pre-baked for 15 minutes on a hotplate heated at 90° C., and then further heated at 385° C. at a reduced pressure for 2 hours, whereby the polyamic acid was imidized into a polyimide. The resulting film was peeled off from the glass substrate to provide a polyimide film (having a thickness of 5.3 μm).

### Example 2

First, 2.71 g of 3,3′,5,5′-tetramethylbenzidine (TMBA) was dissolved in 19.1 ml of dry N,N-dimethylacetamide in a reaction vessel provided with a stirrer. Then, 5.00 g of 4,4′-(hexafluoroisopropylidene)diphthalic dianhydride (6FDA) was slowly added to the resulting solution with stirring, and the resulting mixture was further stirred at 40° C. for 5 hours. Thus, an N,N-dimethylacetamide solution of a polyamic acid (polyimide precursor) was prepared (which had a solid concentration of 30% and an overall weight of 25.0 g).

With the use of the solution of the polyamic acid thus prepared, a polyimide film (having a thickness of 5.6 μm) was produced in substantially the same manner as in Example 1.

### Example 3

First, 1.19 g of 3,3′-dimethylbenzidine (DMBA) and 1.80 g of 2,2′-bis(trifluoromethyl)-4,4′-diaminobiphenyl (TFMB) were blended, and dissolved in 20.0 ml of dry N,N-dimethylacetamide in a reaction vessel provided with a stirrer. Then, 5.00 g of 4,4′-(hexafluoroisopropylidene)diphthalic dianhydride (6FDA) was slowly added to the resulting solution with stirring, and the resulting mixture was further stirred at 40° C. for 5 hours. Thus, an N,N-dimethylacetamide solution of a polyamic acid (polyimide precursor) was prepared (which had a solid concentration of 30% and an overall weight of 26.3 g).

With the use of the solution of the polyamic acid thus prepared, a polyimide film (having a thickness of 5.4 μm) was produced in substantially the same manner as in Example 1.

### Example 4

First, 1.35 g of 3,3′,5,5′-tetramethylbenzidine (TMBA) and 1.80 g of 2,2′-bis(trifluoromethyl)-4,4′-diaminobiphenyl (TFMB) were dissolved in 20.2 ml of dry N,N-dimethylacetamide in a reaction vessel provided with a stirrer. Then, 5.00 g of 4,4′-(hexafluoroisopropylidene)diphthalic dianhydride (6FDA) was slowly added to the resulting solution with stirring, and the resulting mixture was further stirred at 40° C. for 5 hours. Thus, an N,N-dimethylacetamide solution of a polyamic acid (polyimide precursor) was prepared (which had a solid concentration of 30% and an overall weight of 26.5 g).

With the use of the solution of the polyamic acid thus prepared, a polyimide film (having a thickness of 5.8 μm) was produced in substantially the same manner as in Example 1.

### Comparative Example 1

First, 3.60 g of 2,2′-bis(trifluoromethyl)-4,4′-diaminobiphenyl (TFMB) was dissolved in 21.4 ml of dry N,N-dimethylacetamide in a reaction vessel provided with a stirrer. Then, 5.00 g of 4,4′-(hexafluoroisopropylidene)diphthalic dianhydride (6FDA) was slowly added to the resulting solution with stirring, and the resulting mixture was further stirred at 40° C. for 5 hours. Thus, an N,N-dimethylacetamide solution of a polyamic acid (polyimide precursor) was prepared (which had a solid concentration of 30% and an overall weight of 28.0 g).

With the use of the solution of the polyamic acid thus prepared, a polyimide film (having a thickness of 5.5 μm) was produced in substantially the same manner as in Example 1.

The polyimide compounds for the polyimide films of Examples and Comparative Example thus produced each had a structure represented by the following general formula (4), and the molar ratio of structural units (m/n) and substituents R₁ to R₄ are shown in Table 1.

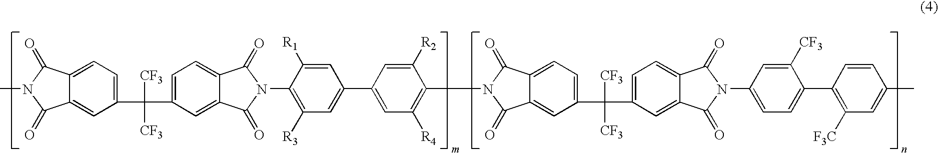

The linear expansion coefficient (ppm/° C.), the loss increase ratio (loss 850/1300) and the weight average molecular weight (Mw) of each of the polyimide compounds for the polyimide films were measured by using the polyimide films as samples. The linear expansion coefficient was measured by means of a thermomechanical analyzer (TMA). The loss increase ratio was measured by means of a spectral analyzer. The weight average molecular weight was measured by the gel permeation chromatography (GPC). The results are also shown in Table 1.

The polyamic acid solutions of Examples and Comparative Example were evaluated for the following properties based on the following criteria.

### Coatability

A polyamic acid solution which did not suffer from gelation in the synthesis of the polyamic acid and maintained its liquid form without any problem in the coating operation was rated as acceptable (◯).

### Reflow Resistance

A reflow resistance test (a decomposition resistance test at not lower than 270° C.) was performed by means of a thermomechanical analyzer (TMA). A test sample having experienced a less than 3% weight reduction was rated as acceptable (◯).

### Curl Resistance

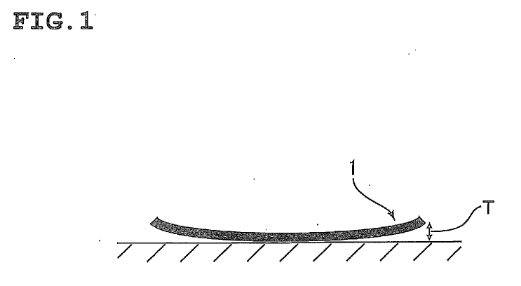

The polyamic acid solutions were each applied onto one surface of a flat SUS substrate (SUS304H-TA available from Nippon Steel Corporation) having a size of 7 cm×7 cm×0.025 mm (thickness), and the resulting coating films were heated at 80° C. for 10 minutes, then at 150° C. for 30 minutes and further at 350° C. for 2 hours. Thus, samples were prepared, which each included a 20-μm thick polyimide layer formed on the SUS substrate. The warpage (curl) of each of the samples thus prepared was measured and evaluated in the following manner. As shown in FIG. 1, a sample 1 was placed on a flat area, and the height T of an edge of the sample 1 was measured. A sample having a height T of not greater than 0.5 cm was rated as acceptable.

TABLE 1

| | | | | | | Comparative |
|---|---|---|---|---|---|---|
| | | Example | | | | Example |
| | | 1 | 2 | 3 | 4 | 1 |
| Molar ratio (m/n) | | 100/0 | 100/0 | 50/50 | 50/50 | 0/100 |
| Substituents | R₁, R₂ | CH₃ | CH₃ | CH₃ | CH₃ | — |
| | R₃, R₄ | H | CH₃ | H | CH₃ | — |

| | | | | | |
|---|---|---|---|---|---|
| Linear expansion coefficient (ppm/° C.) | 19 | 23 | 32 | 35 | 40 |
| Loss increase ratio (loss 850/1300) | 1.23 | 1.16 | 1.63 | 1.64 | 3.48 |
| Weight average molecular weight (Mw) | 57000 | 56000 | 71000 | 68000 | 53000 |
| Coatability | ◯ | ◯ | ◯ | ◯ | ◯ |
| Reflow resistance | ◯ | ◯ | ◯ | ◯ | ◯ |
| Curl resistance (cm) | 0.2 | 0.2 | 0.5 | 0.5 | 0.9 |

As described above, the polyamic acid solutions of Examples 1 to 4 maintained their solution form and, therefore, were excellent in coatability. The polyimide compounds of Examples 1 to 4 prepared by imidizing the polyamic acids were excellent in reflow resistance. Further, the warpage of each of the samples of Examples 1 to 4 was suppressed in the curl test to meet the criteria specified in the present invention.

On the other hand, the sample of Comparative Example 1 suffered from significant warpage in the curl test because of the higher linear expansion coefficient of the film, failing to meet the criteria specified in the present invention. Further, the film prepared in Comparative Example 1 had a higher loss increase ratio and, therefore, was less functional for an optical waveguide adapted for near infrared spectral range.

As shown in Table 1, the films prepared in Examples 1 to 4 each had a lower loss increase ratio and, therefore, were suitable for use in near infrared spectral range. Further, the films of Examples 1 to 4 each had a lower linear expansion coefficient as shown in Table 1 and, even if having a smaller thickness, was less liable to be thermally warped or distorted. Thus, it was confirmed that the films of Examples 1 to 4 each had excellent properties as optical films.

Like the films described above, optical waveguides produced by employing the polyimide compounds of Examples 1 to 4 were less liable to be thermally warped or distorted. Particularly, the results of the curl test indicated that the optical waveguides, even if being produced by employing a metal substrate having a lower linear expansion coefficient, were free from the problem associated with the warpage.

Although specific forms of embodiments of the instant invention have been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention.

What is claimed is:

1. A polyimide compound having a structural unit represented by the following general formula (1): 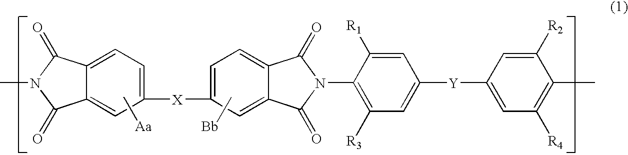
wherein X and Y are each a covalent single bond, —CO—, —O—, —CH₂—, —C(CF₃)₂— or —CR(R′)— (wherein R and R′, which may be the same or different, are each a linear or branched C₁ to C₄ alkyl group); A and B are each a halogen group; a and b, which are the numbers of the groups A and B, respectively, are each 0 or an integer of 1 or 2; and R₁, R₂, R₃ and R₄, which may be the same or different, are each a hydrogen atom or a linear C₁ to C₄ alkyl group.

2. A polyimide compound according to claim 1 having a linear expansion coefficient of not higher than 35 ppm/° C.

3. A preparation method for the polyimide compound according to claim 1, the method comprising the steps of:
causing a tetracarboxylic dianhydride represented by the following general formula (2) and a diamino compound represented by the following general formula (3) to react with each other to prepare a polyamic acid in a liquid form; and
imidizing the polyamic acid in the liquid form, 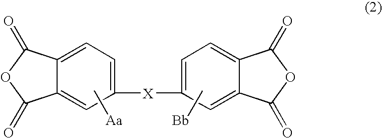
wherein X is a covalent single bond, —CO—, —O—, —CH₂—, —C(CF₃)₂— or —CR(R′)— (wherein R and R′, which may be the same or different, are each a linear or branched C₁ to C₄ alkyl group); A and B are each a halogen group; and a and b, which are the numbers of the groups A and B, respectively, are each 0 or an integer of 1 or 2, 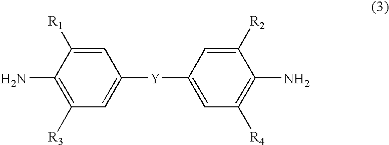
wherein Y is a covalent single bond, —CO—, —O—, —CH₂—, —C(CF₃)₂— or —CR(R′)— (wherein R and R′, which may be the same or different, are each a linear or branched C₁ to C₄ alkyl group); and R₁, R₂, R₃ and R₄, which may be the same or different, are each a hydrogen atom or a linear C₁ to C₄ alkyl group.

4. An optical film composed of a resin comprising the polyimide compound according to claim 1 as a matrix polymer.

5. An optical waveguide comprising:
a substrate;
a cladding layer provided on the substrate; and
a core provided in a predetermined pattern in the cladding layer for transmission of an optical signal;
wherein at least one of the cladding layer and the core is composed of a resin comprising the polyimide compound according to claim 1 as a matrix polymer.
